(19) United States
(12) Patent Application Publication
(10) Pub. No.: US 2011/0214349 A1
(43) Pub. Date: Sep. 8, 2011

(54) ELECTRICAL DOOR DRIVING DEVICE

(76) Inventor: SHU-CHUAN CHAN, Kaohsiung (TW)

(21) Appl. No.: 12/716,284

(22) Filed: Mar. 3, 2010

(51) Int. Cl. E05F 17/00; E05F 15/10

(52) U.S. Cl. 49/120; 49/360

(57) ABSTRACT

The electrical door driving device mainly contains a shaft having threads with a smaller pitch at the two ends and a larger pitch in the middle. A guiding element is configured on the shaft with a guide pin running vertically through the guiding element and into a groove of the shaft. An end of the shaft is connected to a motor and a leaf is connected to the guiding element by a vertical rod. When the motor engages the shaft to spin, the guiding element, and thereby the leaf, is moved as the guide pin traverses the groove of the shaft. As the threads of the shaft are denser at the ends of the shaft, the leaf moves slower when the door starts to close (or when the door starts to open) and when the door is about fully closed (or when the door is about fully opened).

### (a) TECHNICAL FIELD OF THE INVENTION

The present invention generally relates to electrical doors, and more particular to a driving device for a single-leaf or two-leaf electrical door where the leaf or leaves are slowed down when the door is about fully opened or closed.

### (b) DESCRIPTION OF THE PRIOR ART

Electrical doors, such as those used in elevators, are quite common apparatus. There are safety regulations regarding the electrical doors. For example, it is required that, for a two-leaf door, one of the leaves has be configured with a safety edge and detection sensors so that the door is opened once the safety edge is touched or the detection sensor has detected an object. In addition, when a leaf is moved to close the door and an object is caught, the door is opened again if the force exceeds 2 kg. As such, the electrical door is prevented from hurting children or people. Conventionally, the leaf or leaves of an electrical door is moved laterally to open or close the electrical door by the motor-driven rotation of a belt. In order to slow down the leaf or leaves when the door is about fully closed or opened, a long-adopted means is to reduce the current to the motor. However, the leaf or leaves are usually equipped with rollers so as to slide on a track laterally. After a period of usage, dust is accumulated in the track, thereby creating higher resistance to the sliding leaf or leaves. On the other hand, the motor under reduced current input delivers less power to the leaf or leaves. As a result, it is not uncommon that the leaf or leaves fail to reach a desired location when the door is about fully closed or opened. Under this condition, the electrical door is automatically shut down for safety sake, and repair personnel have to be summoned for troubleshooting, leading to a lengthy down time. Further, a resistor is usually used to create a shunt to reduce current to the motor. The temperature of the resistor is therefore usually quite high. And, when the door is fully closed or opened, the current through the resistor is not cut off and therefore the resistor is maintained under a high temperature. When some water is spilt over the resistor when, for example, the adjacent floor is cleaned, the resistor is burned down easily.

### SUMMARY OF THE INVENTION

Therefore, the present invention provides particular to a driving device for a single-leaf or two-leaf electrical door that the leaf or leaves are slowed down when the door is about fully opened or closed without reducing the motor power and without worrying damage by water.

The electrical door driving device mainly contains a shaft having threads with a smaller pitch at the two ends and a larger pitch in the middle. At the two ends of the shaft, a positioning base is provided, respectively. A guiding element is configured on the shaft with a guide pin running vertically through the guiding element and into a groove of the shaft. An end of the shaft is connected to a motor and a leaf is connected to the guiding element by a vertical rod. Beneath the two positioning bases, a switch is provided, respectively. When the motor engages the shaft to spin, the guiding element is moved from a first end of the shaft towards a second end as the guide pin traverses the groove of the shaft. The leaf is thereby moved by the vertical rod laterally along with the guiding element. As the threads of the shaft are denser at the ends of the shaft, the leaf moves slower when the door starts to close (or when the door starts to open) and when the door is about fully closed (or when the door is about fully opened). In between, the leaf move at a faster speed as the shaft has a larger pitch in the middle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an electrical door driving device according to a two-leaf door embodiment of the present invention.

FIG. 2 is a schematic diagram showing an electrical door driving device according to a one-leaf door embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

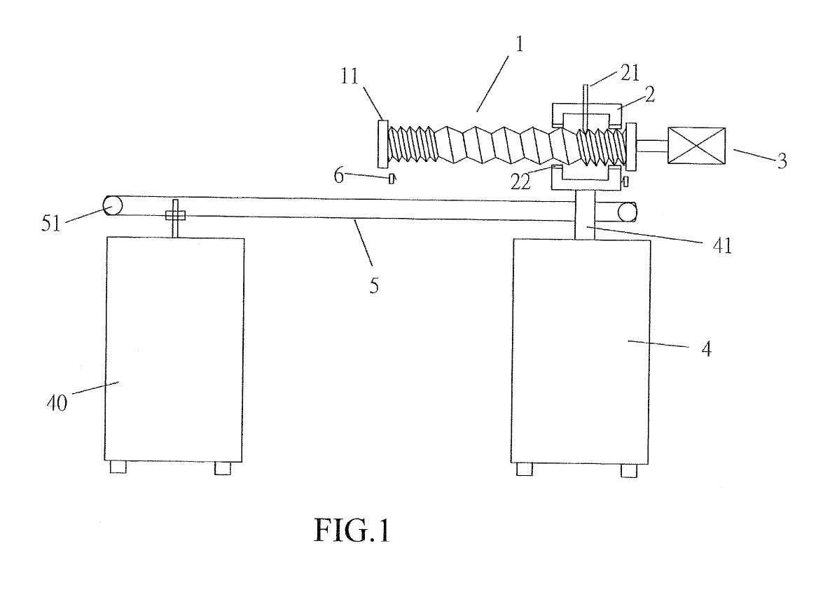

As shown in FIG. 1, an electrical door driving device according to an embodiment to a two-leaf door mainly contains a shaft 1 having threads with a smaller pitch at the two ends and a larger pitch in the middle. At the two ends of the shaft 1, a positioning base 11 is provided, respectively. A guiding element 2 is configured on the shaft 1 with a guide pin 2 running vertically through the guiding element 2 and into a groove of the shaft 1. On the guiding element 2 where it interfaces with the shaft 1, plastic pads 22 are provided. An end of the shaft 1 is connected to a motor 3 and a first leaf 4 is connected to the guiding element 2 by a vertical rod 41. A steel cable 5 runs a close loop between two rollers 51 and connects the first leaf 4 and a second leaf 41 in such a way that they either move towards or away from each other. Beneath the two positioning bases 11, a switch 6 is provided, respectively.

When the motor 3 engages the shaft 1 to spin, the guiding element 2 is moved from a first end of the shaft 1 towards a second end as the guide pin 21 traverses the groove of the shaft 1. The first leaf 4 is thereby moved by the vertical rod 41 laterally along with the guiding element 2. In the mean time, the steel cable 5 pulls the second leaf 40 laterally at a same speed towards the first leaf 4. As such, the two leaves 4 and 40 gradually close the door. On the other hand, if the motor 3 spins the shaft 1 along an opposite direction, the two leaves 4 and 40 are moved laterally apart to open the door, by the same mechanism described above. As the threads of the shaft 1 are denser at the ends of the shaft 1, the two leaves 4 and 40 move slower when the door starts to close (or when the door starts to open) and when the door is about fully closed (or when the door is about fully opened). In between, the leaves 4 and 40 move at a faster speed as the shaft 1 has a larger pitch in the middle. As the present invention relies on mechanical mechanism in driving the leaves 4 and 40, their drive is not reduced even though they are slowed down when the door is about to fully closed or opened. As such, the leaves 4 and 40 could be precisely positioned to desired locations without causing breakdown. Also because the mechanical mechanism, the present invention does not require current distribution elements and the chance of malfunction is reduced as fewer components are required. In addition, waterproofing could be easily achieved for the present invention.

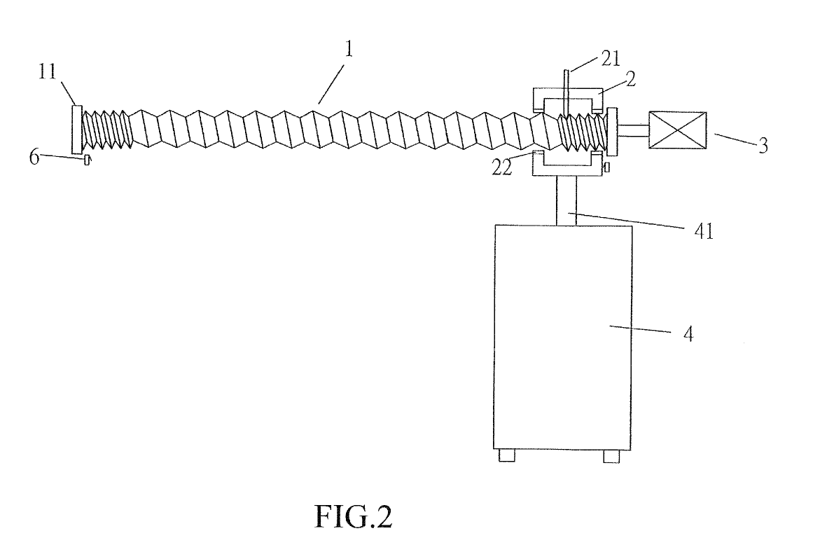

FIG. 2 shows an electrical door driving device according to a one-leaf door embodiment. The driving device contains a shaft 1 having threads with a smaller pitch at the two ends and a larger pitch in the middle. At the two ends of the shaft 1, a positioning base 11 is provided, respectively. A guiding element 2 is configured on the shaft 1 with a guide pin 2 running vertically through the guiding element 2 and into a groove of the shaft 1. On the guiding element 2 where it interfaces with the shaft 1, plastic pads 22 are provided. An end of the shaft 1 is connected to a motor 3 and a leaf 4 is connected to the guiding element 2 by a vertical rod 41. Beneath the two positioning bases 11, a switch 6 is provided, respectively.

When the motor 3 engages the shaft 1 to spin, the guiding element 2 is moved from a first end of the shaft 1 towards a second end as the guide pin 21 traverses the groove of the shaft 1. The leaf 4 is thereby moved by the vertical rod 41 laterally along with the guiding element 2. As such, the leaf 4 gradually closes the door. On the other hand, if the motor 3 spins the shaft 1 along an opposite direction, the leaf 4 is moved laterally to open the door, by the same mechanism described above. As the threads of the shaft 1 are denser at the ends of the shaft 1, the leaf 4 moves slower when the door starts to close (or when the door starts to open) and when the door is about fully closed (or when the door is about fully opened). In between, the leaf 4 moves at a faster speed as the shaft 1 has a larger pitch in the middle. As the present invention relies on mechanical mechanism in driving the leaf 4, its drive is not reduced even though it is slowed down when the door is about to fully closed or opened. As such, the leaf 4 could be precisely positioned to a desired location without causing breakdown. Also because the mechanical mechanism, the present invention does not require current distribution elements and the chance of malfunction is reduced as fewer components are required. In addition, waterproofing could be easily achieved for the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electrical door driving device, comprising:
a shaft with threads of a smaller pitch at the ends and of a larger pitch in the middle, each end of said shaft configured with a positioning base;
a guiding element on said shaft having a guide pin running vertically through said guiding element into a groove of said shaft;
a motor connecting an end of said shaft;
a door having a first leaf and a second leaf, said first leaf connected to said guiding element by a vertical rod;
a steel cable connecting said first and second leaves such that, when said first leaf moves, said second leaf moves in an opposite direction; and
a switch configured beneath each positioning base.

2. An electrical door driving device, comprising:
a shaft with threads of a smaller pitch at the ends and of a larger pitch in the middle, each end of said shaft configured with a positioning base;
a guiding element on said shaft having a guide pin running vertically through said guiding element into a groove of said shaft;
a motor connecting an end of said shaft;
a door having a leaf, said leaf connected to said guiding element by a vertical rod; and
a switch configured beneath each positioning base.
